(19) United States
(12) Patent Application Publication
(10) Pub. No.: US 2024/0106247 A1
(43) Pub. Date: Mar. 28, 2024

(54) Power Storage System

(71) Applicant: TOYOTA JIDOSHA KABUSHIKI KAISHA, Toyota-shi Achi-ken (JP)

(72) Inventor: Yoshiaki KIKUCHI, Toyota-shi Aichi-ken (JP)

(73) Assignee: TOYOTA JIDOSHA KABUSHIKI KAISHA, Toyota-shi Aichi-ken (JP)

(21) Appl. No.: 18/369,871

(22) Filed: Sep. 19, 2023

(30) Foreign Application Priority Data
Sep. 27, 2022 (JP) 2022-153663

(51) Int. Cl. H02J 7/00; G06F 1/26; H01M 10/0525; H01M 10/46; H01M 50/512

(52) U.S. Cl. CPC H02J 7/00047; G06F 1/266; H01M 10/0525; H01M 10/46; H01M 50/512; H02J 7/00045; H02J 7/0013; H02J 2207/20

(57) ABSTRACT

A power storage system includes: a power conversion device to which power is supplied from an external system; and a controller that controls an operation of the power conversion device. First and second battery packs different from each other in type are connected to the power conversion device in parallel. The controller stores a first charge profile for the first battery pack and a second charge profile for the second battery pack. The controller charges the first battery pack by operating the power conversion device based on the first charge profile. The controller charges the second battery pack by operating the power conversion device based on the second charge profile.

### CROSS-REFERENCE TO RELATED APPLICATIONS

This nonprovisional application is based on Japanese Patent Application No. 2022-153663 filed on Sep. 27, 2022 with the Japan Patent Office, the entire contents of which are hereby incorporated by reference.

### BACKGROUND

### Field

The present disclosure relates to a power storage system.

### Description of the Background Art

Japanese Patent Application Laid-Open No. 2014-103804 discloses a battery system in which a plurality of battery packs are connected in parallel.

### SUMMARY

In the system disclosed in Japanese Patent Application Laid-Open No. 2014-103804, the plurality of battery packs may be different from each other in type. In such a case, it is desired to efficiently charge the battery packs.

The present disclosure provides a power storage system to effectively charge each of different types of battery packs connected in parallel in the power storage system.

According to an aspect of the present disclosure, a power storage system includes: a power conversion device to which power is supplied from an external system; and a controller that controls an operation of the power conversion device. First and second battery packs different from each other in type are connected to the power conversion device in parallel. The controller stores a first charge profile for the first battery pack and a second charge profile for the second battery pack. The controller charges the first battery pack by operating the power conversion device based on the first charge profile. The controller charges the second battery pack by operating the power conversion device based on the second charge profile.

According to the above configuration, the first battery pack is charged using the first charge profile for the first battery pack. The second battery pack is charged using the second charge profile for the second battery pack. Accordingly, in the power storage system in which the different types of battery packs are connected in parallel, each battery pack can be charged efficiently.

In some embodiments, the power conversion device has a first terminal and a second terminal. One of the first and second battery packs is connected to the first terminal. The other of the first and second battery packs is connected to the second terminal. The controller obtains identification information for identifying a type of a corresponding battery pack connected to each of the first terminal and the second terminal. From the first and second charge profiles, the controller selects, based on the identification information, a charge profile to be used to charge the battery pack connected to the first terminal and a charge profile to be used to charge the battery pack connected to the second terminal. The controller charges the battery pack connected to the first terminal and the battery pack connected to the second terminal by operating the power conversion device based on the selected charge profiles.

According to the above configuration, the controller can identify the types of the battery packs connected to the first terminal and the second terminal. Therefore, according to the above configuration, each battery pack can be charged based on an appropriate charge profile.

In some embodiments, the first battery pack is a ternary lithium ion battery. The second battery pack is an iron-phosphate-based lithium ion battery.

According to the above configuration, in the power storage system in which the ternary battery and the LFP battery are connected in parallel, each battery pack can be charged efficiently.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating a configuration of a power storage system and an external system.

FIG. 2 is a block diagram illustrating a charging process in the battery unit.

FIG. 3 is a flowchart illustrating a flow of processing executed in the power storage system.

### DESCRIPTION OF THE EMBODIMENTS

Hereinafter, embodiments of the present disclosure will be described with reference to the drawings. In the following description, the same members are denoted by the same reference numerals. Their names and functions are also the same. Therefore, detailed description thereof will not be repeated.

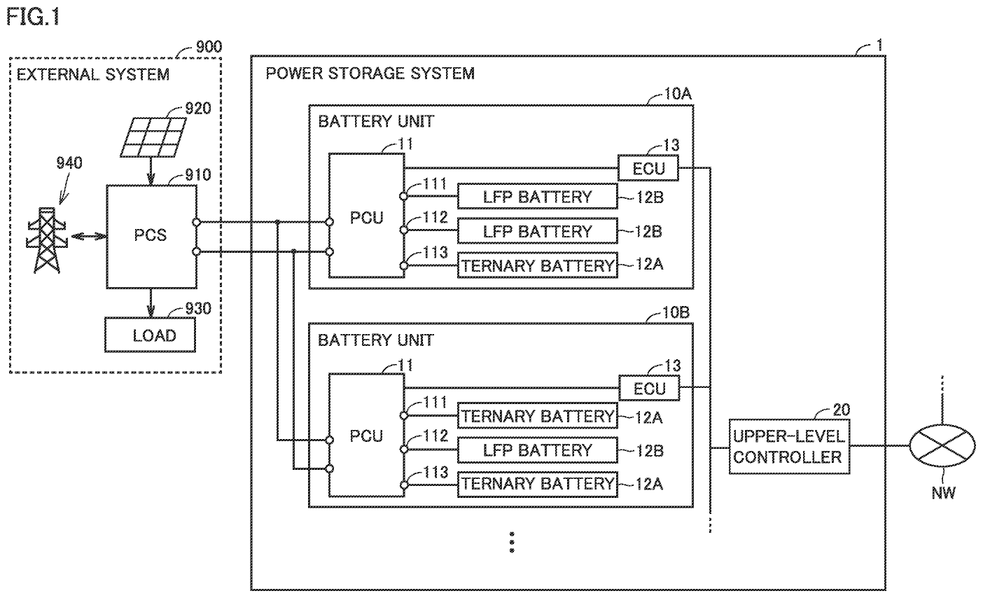

FIG. 1 is a diagram illustrating a configuration of a power storage system and an external system. As shown in FIG. 1, the power storage system 1 is connected to an external system 900 via a power line. The power storage system 1 can supply power from an external system 900. The power storage system 1 can be discharged to the external system 900.

The power storage system 1 includes a plurality of battery units 10A, 10B, . . . , and an upper-level controller 20. Hereinafter, any one of the plurality of battery units 10A, 10B, . . . , is also referred to as a “battery unit 10”.

The battery unit 10A includes a power control unit (PCU) 11, a ternary lithium ion battery (hereinafter referred to as a ternary battery) 12A, two iron-phosphate-based lithium ion batteries (hereinafter referred to as a “LFP battery”) 12B, and an electronic control unit (ECU) (controller) 13. The PCU 11 is a power conversion device including an inverter, a DC/DC converter, and the like. In the battery unit 10A, one ternary battery (first battery pack) 12A and two LFP batteries (second battery pack) 12B are connected in parallel to the PCU 11.

More specifically, it includes three terminals (first terminal and second terminal) 111, 112, and 113 for external connection of the PCU 11. The LFP battery 12B is connected to terminals 111 and 112 among the three terminals. A ternary battery 12A is connected to a terminal 113 among the three terminals.

The battery unit 10B includes a PCU 11, two ternary batteries (first battery pack) 12A, one LFP battery (second battery pack) 12B, and an ECU (controller) 13. In the battery unit 10B, two ternary batteries 12A and one LFP battery 12B are connected in parallel to the PCU 11. The ternary battery 12A is connected to the terminals 111 and 113. The LFP battery 12B is connected to the terminal 112. The battery unit 10B is different from the battery unit 10A in a combination of battery packs connected to the PCU 11.

Each of the ternary battery 12A and the LFP battery 12B is an example of a battery pack (also referred to as a “battery pack”) in which a plurality of single cells of the same type are packed. The battery unit 10 includes three battery packs connected in parallel to each other in the PCU 11. The power storage system 1 may include a battery unit 10 including only three ternary batteries 12A or a battery unit 10 including only three LFP batteries 12B.

In this example, as the PCU 11 and the ECU 13, the PCU and the ECU mounted on the vehicle are used, respectively. Similarly, as the ternary battery 12A and the LFP battery 12B, the assembled battery mounted on the vehicle is used. In this way, the power storage system 1 is constructed by using the unnecessary components of the vehicle. Specifically, the three-phase AC motor connected to the PCU of the vehicle is detached, and three battery packs (one in each of the U layer, the V layer, and the W layer) are connected. The terminals 111, 112, and 113 are a terminal for the U layer, a terminal for the V layer, and a terminal for the W layer, respectively.

The external system 900 includes PCS (Power Conditioning System) 910, a photovoltaic power generator 920, a load 930, and a power system 940. The battery units 10 (more specifically, the PCUs 11) are connected in parallel to the PCS 910.

The PCS 910 is a power conversion device capable of both AC/DC conversion (conversion from AC to DC) and DC/AC conversion (conversion from DC to AC). The PCS 910 receives DC power from, for example, the photovoltaic power generator 920. PCS 910 supplies AC power to load 930. The load 930 includes electric products (e.g., air conditioners and lighting equipment) used in households. The PCS 910 exchanges AC power with the power system 940.

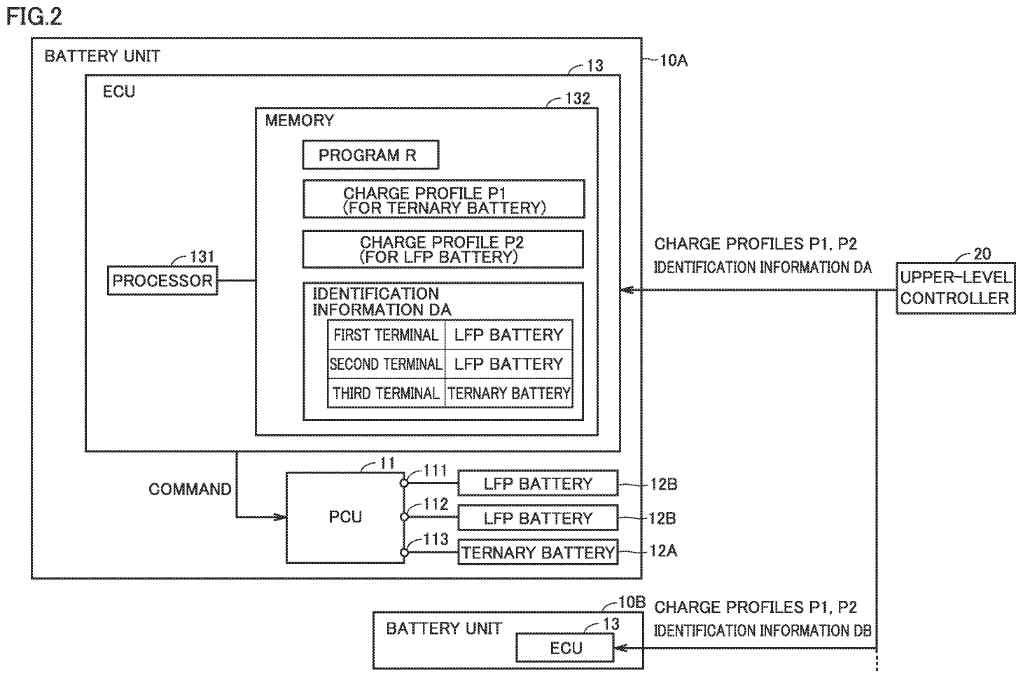

Each ECU 13 includes a processor and a memory (see FIG. 2). Each ECU 13 controls the battery unit 10. Each ECU 13 is communicably connected to the upper-level controller 20.

The upper-level controller 20 includes a processor and a memory (both not shown). The upper-level controller 20 sends a command to each ECU 13. The upper-level controller 20 is communicably connected to a server (not shown) via a network NW.

In the power storage system 1, each battery unit 10 is charged by the external system 900 at least in a late night time period. Each battery unit 10 discharges to the external system 900 at least in the daytime period. Specifically, in each battery unit 10, each of the three battery packs is supplied with power from the external system 900 in at least a late night time period. Each of the three battery packs discharges to the external system 900 at least in the daytime period.

Incidentally, the ternary battery 12A and the LFP battery 12B have different battery characteristics. For example, the ternary battery 12A and the LFP battery 12B have different SOC-OCV characteristics, which are one of battery characteristics. The OCV (V) of the ternary battery 12A is larger than the OCV (V) of the LFP battery 12B over the entire region of the SOC (%). Note that SOC (State Of Charge) represents the state of charge (charge rate) of the battery. An open circuit voltage (OCV) indicates an open circuit voltage of the battery.

Since there is such a difference in battery characteristics, the charging efficiency is higher when the ternary battery 12A and the LFP battery 12B are charged using a charge profile corresponding to the type of battery than when the ternary battery 12A and the LFP battery 12B are charged using the same charge profile. Therefore, in the power storage system 1, the ternary battery 12A and the LFP battery 12B are charged using different charge profiles.

FIG. 2 is a block diagram illustrating a charging process in the battery unit 10A. As shown in FIG. 2, the ECU 13 includes a processor 131 and a memory 132.

The battery unit 10A acquires the charge profile P1 for the ternary battery, the charge profile P2 for the LFP battery, and the identification information DA indicating the battery type in the battery unit 10A from the upper-level controller 20. The charge profiles P1 and P2 and the identification information DA are stored in the memory 132.

A program R is installed in advance in the memory 132. The program R may be transmitted from the upper-level controller 20 to the ECU 13. The charge profiles P1 and P2 and the identification information DA may be stored in advance in the memory 132 without passing through the upper-level controller 20.

The charge profiles P1 and P2 are data (files) in which various settings at the time of charge are written. The charge profile P1 is configured to be suitable for charging the ternary battery. The charge profile P2 is configured to be suitable for charging the LFP battery.

In this example, the charge profile P1 is a profile for executing constant-current constant-voltage charge (CCCV: Constant Current Constant Voltage) that manages voltage and current. The charge profile P1 defines the relationship between the voltage and the current. Specifically, in the charge profile P1, in the case of charge from the discharge state, the battery pack is initially charged in a constant current state because the voltage is low, and when the amount of charge gradually increases and the cell voltage reaches a predetermined voltage, the battery pack is switched to constant voltage charge. In the charge profile P1, after switching to constant voltage charge, the amount of current is reduced so as not to exceed the predetermined voltage. The full charge is determined from a decrease in charge time and charge current.

In this example, the charge profile P2 is a profile of a system for managing a voltage. Specifically, the charge profile P2 is a profile of a method of managing the charge capacity in addition to the voltage.

The program R is configured to execute charge control according to the charge profiles P1 and P2. By being executed by the processor 131, the program R generates a control command based on the charge profiles P1 and P2, and sends the control command to the PCU 11.

The processor 131 refers to the identification information DA and sends a control command corresponding to the type of battery pack to each battery pack in the battery unit 10A. Specifically, the identification information DA is information for identifying the types of battery packs connected to the three terminals 111, 112, and 113 of the battery unit 10A. In this example, the identification information DA indicates that the LFP battery 12B is connected to the first terminal indicating the terminal 111 and the second terminal indicating the terminal 112. The identification information DA further indicates that the ternary battery 12A is connected to the third terminal indicating the terminal 113.

The processor 131 determines the types of battery packs connected to the three terminals 111, 112, and 113 based on the identification information DA. Thus, the processor 131 selects, from among the charge profile P1 and the charge profile P2, the charge profile for the battery pack connected to the terminal 111 (the charge profile P2 in this example), the charge profile for the battery pack connected to the terminal 112 (the charge profile P2 in this example), and the charge profile for the battery pack connected to the terminal 113 (the charge profile P1 in this example).

The ECU 13 of the battery unit 10A charges one ternary battery 12A and two LFP batteries 12B by operating the PCU 11 based on the selected charge profile. Specifically, as described above, the ECU 13 operates the PCU 11 based on the charge profile P2 to charge the LFP battery 12B connected to the terminal 111 (first terminal) and the LFP battery 12B connected to the terminal 112 (second terminal). The ECU 13 charges the ternary battery 12A connected to the terminal 113 (third terminal) by operating the PCU 11 based on the charge profile P1.

In the battery unit 10B, the same processing as in the battery unit 10A is executed. In this case, the upper-level controller 20 sends the identification information DB to the battery unit 10B instead of the identification information DA. The identification information DB indicates that the ternary battery 12A is connected to each of the first terminal indicating the terminal 111 and the third terminal indicating the terminal 113. The identification information DB further indicates that the LFP battery 12B is connected to the second terminal indicating the terminal 112.

The ECU 13 of the battery unit 10B charges two ternary batteries 12A and one LFP battery 12B by operating the PCU 11 based on the identification information DB (see FIG. 1). Specifically, the ECU 13 of the battery unit 10B charges the ternary battery 12A connected to the terminal 111 and the ternary battery 12A connected to the terminal 113 by operating the PCU 11 based on the charge profile P1. The ECU 13 of the battery unit 10B charges the LFP battery 12B connected to the terminal 112 by operating the PCU 11 based on the charge profile P2.

For example, when the type of the battery pack connected to any one of the terminals 111, 112, and 113 of the battery unit 10A changes due to replacement of the battery pack in the battery unit 10A, the upper-level controller 20 acquires new identification information DA′ via the network NW. The identification information DA′ is generated, for example, by a user inputting data to a server device (not shown).

The upper-level controller 20 sends the identification information DA′ to the ECU 13 of the battery unit 10A together with an update command of the identification information. The ECU 13 of the battery unit 10A updates the identification information DA with the identification information DA′. Then, the ECU 13 of the battery unit 10A determines which type of battery pack is connected to each of the terminals 111, 112, and 113 based on the identification information DA′. Based on the determination, the ECU 13 of the battery unit 10A charges the battery packs with the charge profiles P1 and P2 corresponding to the types.

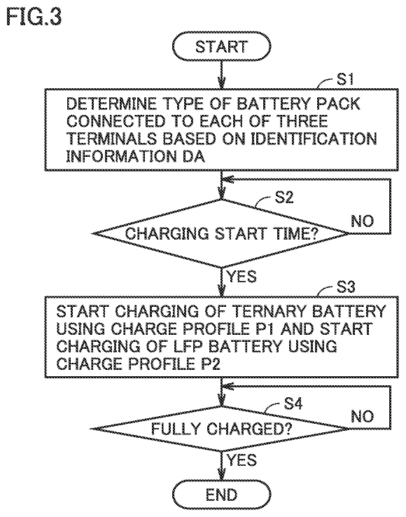

FIG. 3 is a flowchart illustrating a flow of processing executed by the power storage system 1. More specifically, FIG. 3 is a flowchart illustrating a flow of processing executed by the battery unit 10A. The same processing is performed in the battery units 10 other than the battery unit 10A.

As shown in FIG. 3, in step S1, the ECU 13 of the battery unit 10A determines the type of battery pack connected to each of the three terminals 111, 112, and 113 based on the identification information DA. Specifically, the ECU 13 determines whether the battery pack connected to each of the three terminals 111, 112, and 113 is the ternary battery 12A or the LFP battery 12B for each of the terminals 111, 112, and 113.

In step S2, the ECU 13 determines whether or not the charging start time is reached. Specifically, the ECU 13 has a clock (not shown), and determines whether or not the charging start time has been reached based on the clock. An example of the charge start time is 18 o'clock.

When the ECU 13 determines that the charging start time is reached (YES in step S2), the ECU 13 starts the charging of one ternary battery 12A by operating the PCU 11 based on the charge profile P1 in step S3. At the same time, the ECU 13 starts charging the two LFP batteries 12B by operating the PCU 11 based on the charge profile P2 in step S3.

In step S4, the ECU 13 determines whether or not each of the three battery packs has been fully charged. When the ECU 13 determines that each of the three battery packs has been fully charged (YES in step S4), the ECU 13 ends the series of processes. When the ECU 13 determines that each of the three battery packs is not fully charged (NO in step S4), the ECU 13 continues to charge each battery pack until each of the three battery packs is fully charged.

<Parenthesis>

The power storage system 1 is summarized as follows.
(1) The power storage system 1 includes a PCU 11 to which power is supplied from an external system 900, and an ECU 13 which controls the operation of the PCU 11. The PCU 11 is connected in parallel with a ternary battery and an LFP battery of different types. The ECU 13 stores a charge profile P1 for the ternary battery and a charge profile P2 for the LFP battery. The ECU 13 charges the ternary battery 12A by operating the PCU 11 based on the charge profile P1. The ECU 13 charges the LFP battery 12B by operating the PCU 11 based on the charge profile P2.

According to the above configuration, the ternary battery 12A is charged using the charge profile P1 for the ternary battery. The LFP battery 12B is charged using the charge profile P2 for the LFP battery. Accordingly, the battery packs (the ternary battery 12A and the LFP battery 12B) of different types can be efficiently charged in the power storage system 1 connected in parallel. For example, compared to a configuration in which the ternary battery 12A and the LFP battery 12B are charged using the same charge profile, according to the above configuration, the ternary battery 12A and the LFP battery 12B can be efficiently charged.
(2) The PCU 11 includes at least a terminal 111 and a terminal 112. One of the ternary battery 12A and the LFP battery 12B is connected to the terminal 111. The other of the ternary battery 12A and the LFP battery 12B is connected to the terminal 112. The ECU 13 acquires identification information for identifying the type of battery pack connected to each of the terminal 111 and the terminal 112.

Based on the identification information, the ECU 13 selects a charge profile used for charging the battery pack connected to the terminal 111 and a charge profile used for charging the battery pack connected to the terminal 112 from the charge profile P1 and the charge profile P2. The ECU 13 operates the PCU 11 based on each selected charge profile to charge the battery pack connected to the terminal 111 and the battery pack connected to the terminal 112.

According to the above configuration, since the ECU 13 can identify the type of battery pack connected to the terminal 111 and the terminal 112, it is possible to charge each battery pack based on an appropriate charge profile.

### Modified Example

(1) In the above description, the ternary battery and the LFP battery are exemplified as different types of battery packs, but the present disclosure is not limited thereto. The charge treatment described above can also be performed on two or more battery packs with a charge profile suitable for each battery pack.

(2) In the above description, the three battery packs are connected to the power conversion device (the PCU 11 in this example). For example, two or four or more battery packs may be connected to the power conversion device.

### APPENDIX

(1) A charging control method for a power storage system that stores power using an external system, wherein
the power storage system has a power conversion device to which power is supplied from the external system, and first and second battery packs different from each other in type are connected to the power conversion device in parallel,
the charging control method comprising:
charging, by controller of the power storage system, the first battery pack by operating the power conversion device based on a charge profile for the first battery pack; and
charging, by the controller, the second battery pack by operating the power conversion device based on a charge profile for the second battery pack.
(2) A program R that causes a processor 131 to perform each step of the charging control method.
(3) A non-transitory computer readable storage medium storing the program R.
(4) The non-transitory computer readable storage medium further storing the first and second profiles.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage system comprising:
a power conversion device to which power is supplied from an external system; and
a controller that controls an operation of the power conversion device, wherein
first and second battery packs different from each other in type are connected to the power conversion device in parallel,
the controller stores a first charge profile for the first battery pack and a second charge profile for the second battery pack,
the controller charges the first battery pack by operating the power conversion device based on the first charge profile, and
the controller charges the second battery pack by operating the power conversion device based on the second charge profile.

2. The power storage system according to claim 1, wherein
the power conversion device has a first terminal and a second terminal,
one of the first and second battery packs is connected to the first terminal, and the other of the first and second battery packs is connected to the second terminal,
the controller obtains identification information for identifying a type of a corresponding battery pack connected to each of the first terminal and the second terminal,
from the first and second charge profiles, the controller selects, based on the identification information, a charge profile to be used to charge the battery pack connected to the first terminal and a charge profile to be used to charge the battery pack connected to the second terminal, and
the controller charges the battery pack connected to the first terminal and the battery pack connected to the second terminal by operating the power conversion device based on the selected charge profiles.

3. The power storage system according to claim 1, wherein
the first battery pack is a ternary lithium ion battery, and
the second battery pack is an iron-phosphate-based lithium ion battery.
